(19) United States
(12) Patent Application Publication
(10) Pub. No.: US 2012/0082504 A1
(43) Pub. Date: Apr. 5, 2012

(54) Loose-leaf binder

(76) Inventor: Sheng-Tan Wang, Changhua (TW)

(21) Appl. No.: 12/895,874

(22) Filed: Oct. 1, 2010

(51) Int. Cl. B42F 13/02

(52) U.S. Cl. 402/21

(57) ABSTRACT

A loose-leaf binder includes a folding cover; a sheet retaining mechanism secured to a folding portion of the cover and comprising an elongated, rectangular recess, a slit at either end of the recess, a plurality of spaced concave members between both ends, and a plurality of spaced clamps between both ends; and a continuous wire having two straight ends and comprising a plurality of flexible spaced C-shaped rings connected together, the C-shaped rings being adapted to retain a plurality of sheets of paper. The ends of the wire are retained in the slits, a portion of the wire between both ends is fastened by the clamps, and the C-shaped rings are urged against the concave members.

### BACKGROUND OF THE INVENTION

1. Field of Invention

The invention relates to ring binders and more particularly to a loose-leaf binder with an improved sheet retaining mechanism.

2. Description of Related Art

A sheet retaining mechanism A for a typical spiral bound note book is shown in FIG. 1. The sheet retaining mechanism A is implemented as a helical metal wire shaped as a plurality of spaced rings. Each ring loops through one of a plurality of holes along an inner lateral side of either cover C and one of a plurality of perforations of a sheet of paper B. Thus, the sheets of paper B are stacked.

However, a couple of drawbacks have been found. For example, the metal wire A is exposed. This is not visually attractive. Further, the holes of the covers C may be damaged after a period of time of use. This can shorten the useful life of the note book. Thus, the need for improvement still exists.

### SUMMARY OF THE INVENTION

It is therefore one object of the invention to provide a loose-leaf binder comprising a folding cover; a sheet retaining mechanism secured to a folding portion of the cover and comprising an elongated, rectangular recess, a slit at either end of the recess, a plurality of spaced concave members between both ends, and a plurality of spaced clamps between both ends; and a continuous wire having two straight ends and comprising a plurality of flexible spaced C-shaped rings connected together, the C-shaped rings being adapted to retain a plurality of sheets of paper, wherein the ends of the wire are retained in the slits, a portion of the wire between both ends are fastened by the clamps, and the C-shaped rings are urged against the concave members.

The above and other objects, features and advantages of the invention will become apparent from the following detailed description taken with the accompanying drawings.

### BRIEF DESCRIPTION OF THE DRAWINGS

FIG. 1 is a perspective view of a typical spiral bound notebook being open;

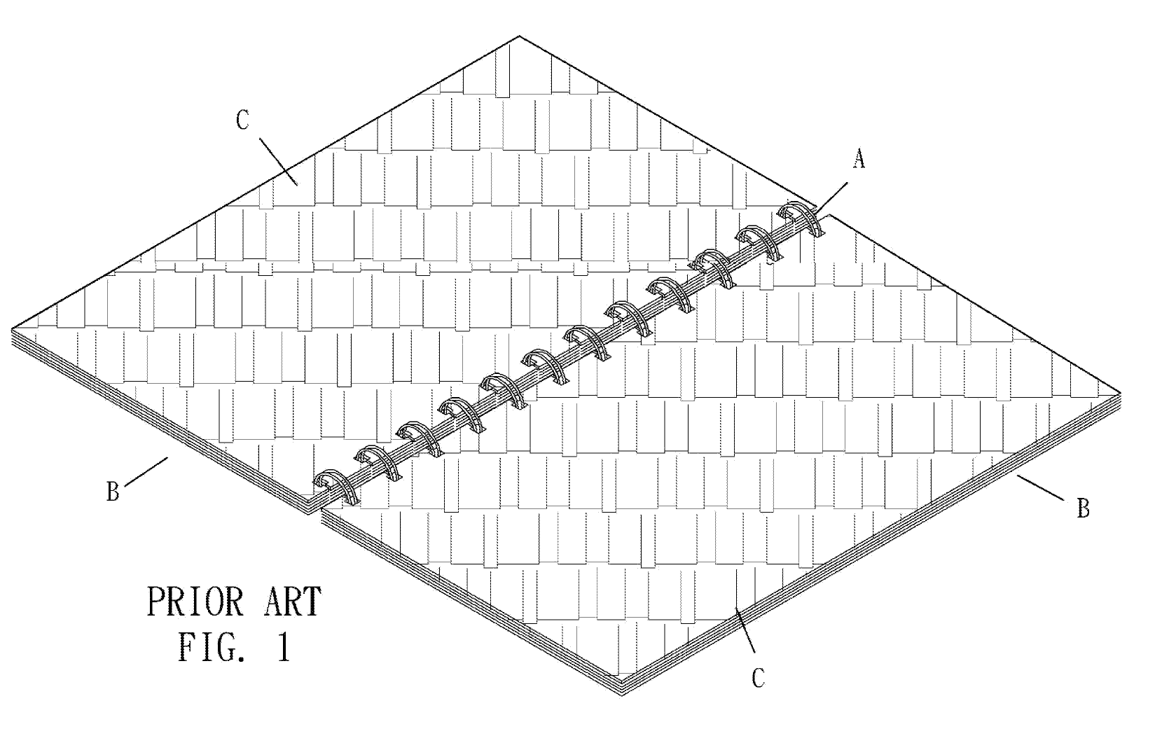

FIG. 2 is a sheet retaining mechanism of a loose-leaf binder according to the invention;

FIG. 3 is an enlarged view of the left end portion of FIG. 2;

FIG. 4 depicts a step of binding sheets of paper by means of a continuous metal wire, shaped as a plurality of spaced C-rings, according to the invention;

FIG. 5 is an exploded view showing the bound sheets of paper to be assembled with the sheet retaining mechanism which is in turn to be secured to a hard cover;

FIG. 6 is an exploded view of the assembled sheets of paper, the sheet retaining mechanism, and the cover of FIG. 5 with one portion of the sheets of paper removed;

FIG. 7 is an enlarged view of a portion proximate the left end of the sheet retaining mechanism shown in FIG. 6;

FIG. 8 is an enlarged view of the right end portion of the sheet retaining mechanism and portions of the stacked sheets of paper shown in FIG. 6; and

FIG. 9 is a perspective view of the binder being closed.

### DETAILED DESCRIPTION OF THE INVENTION

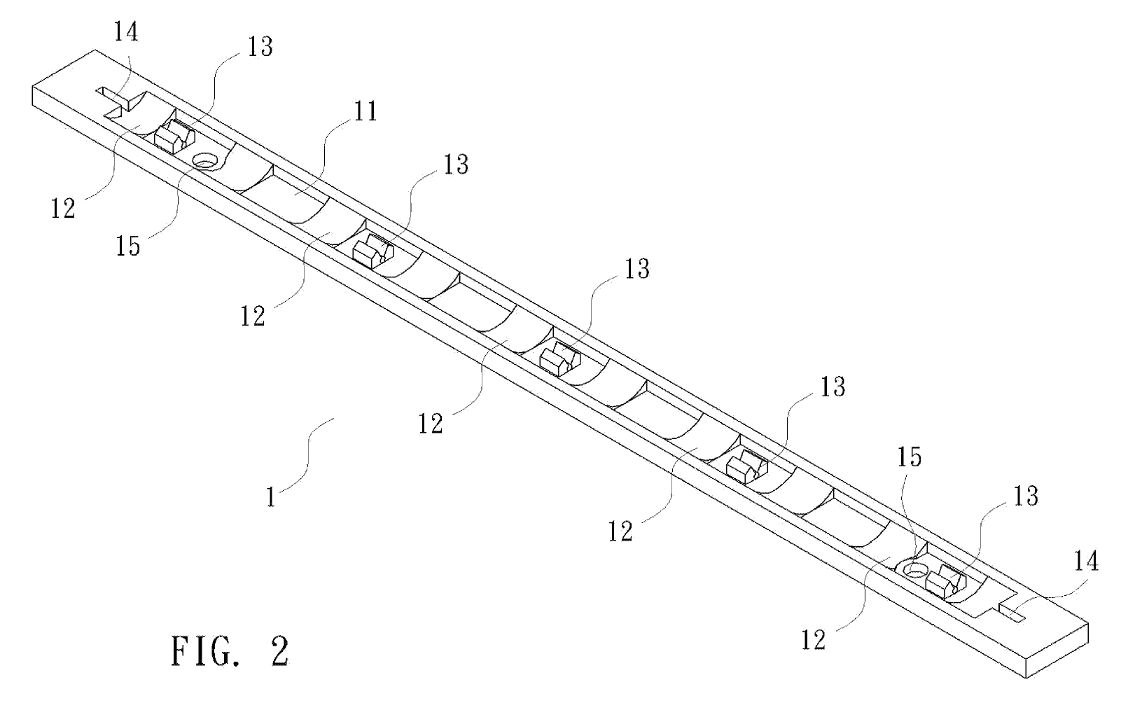

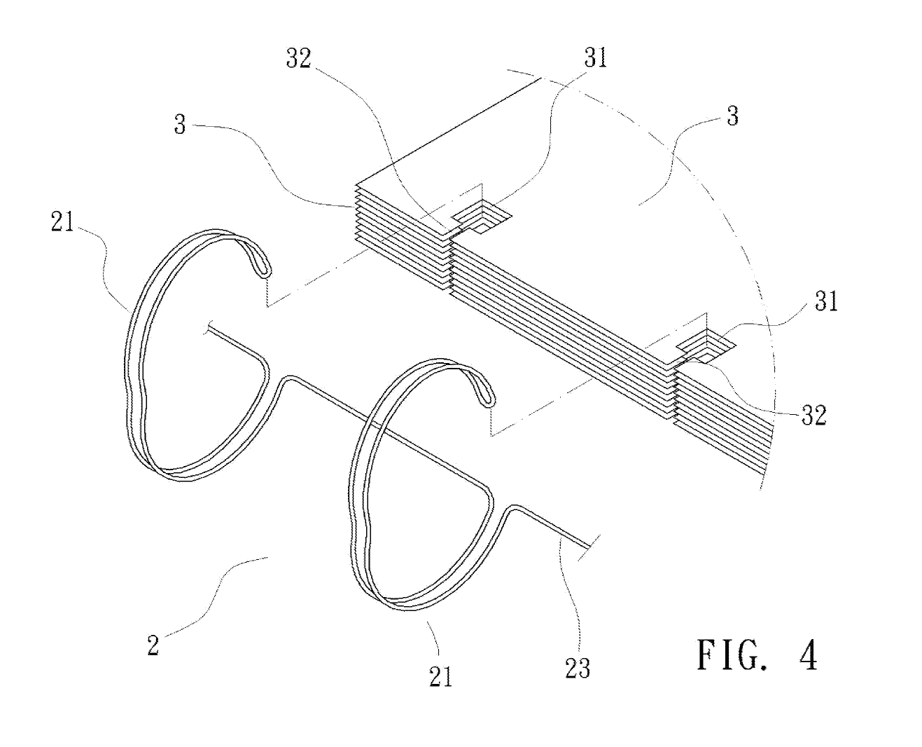

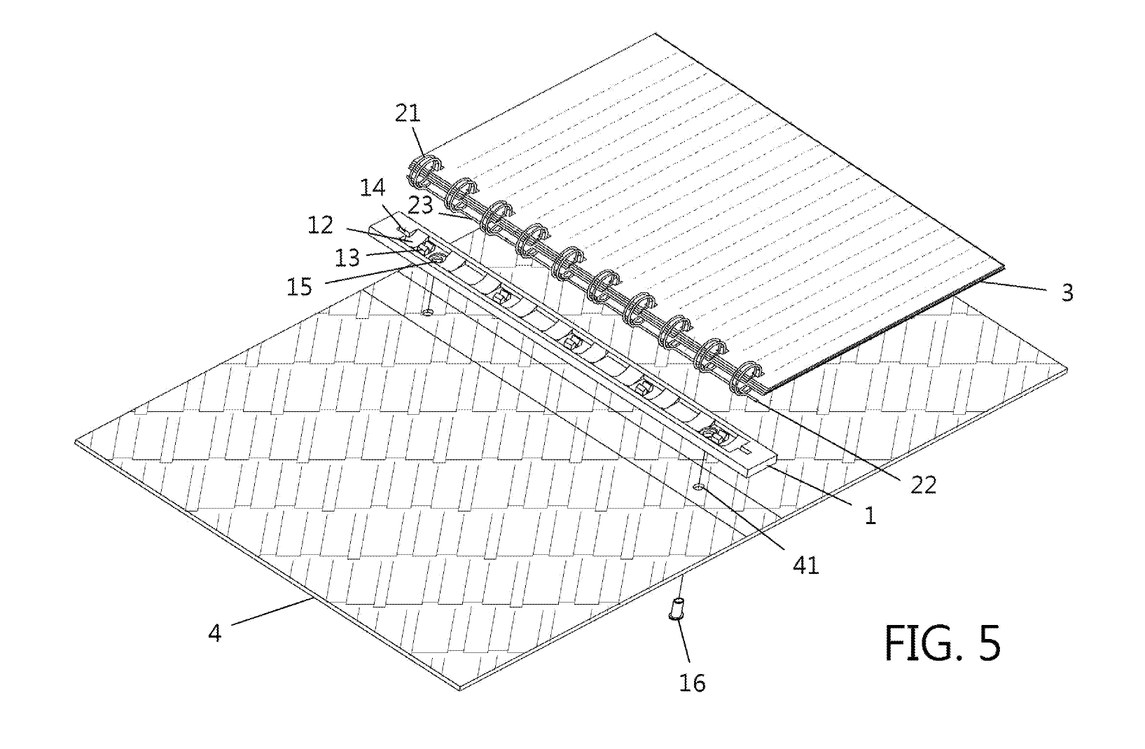

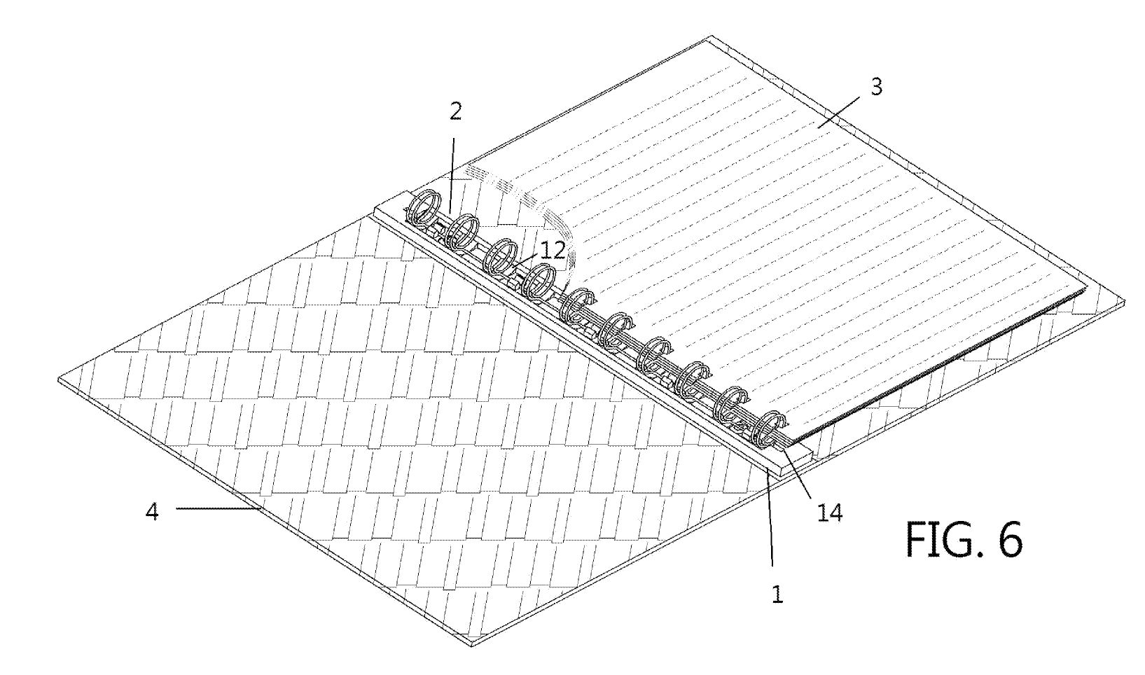

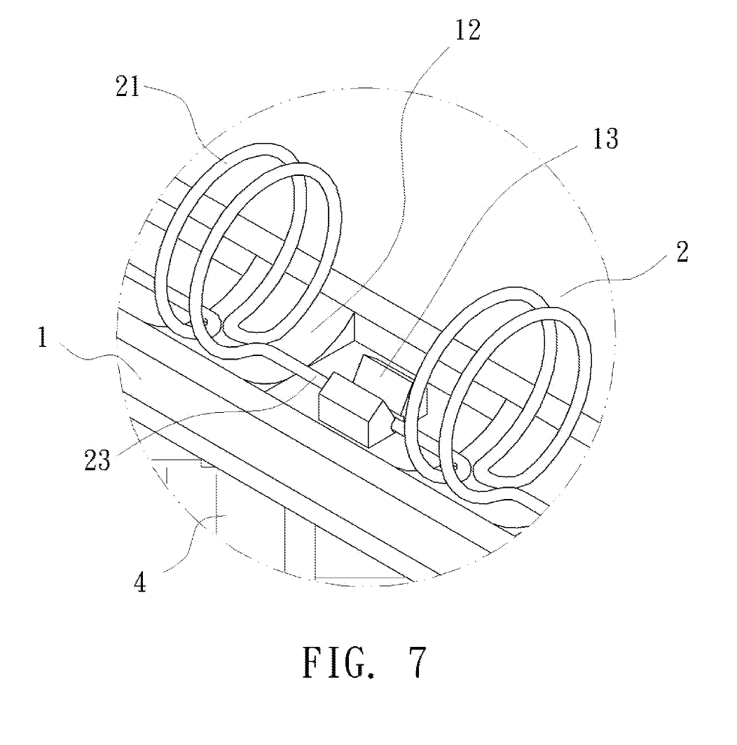

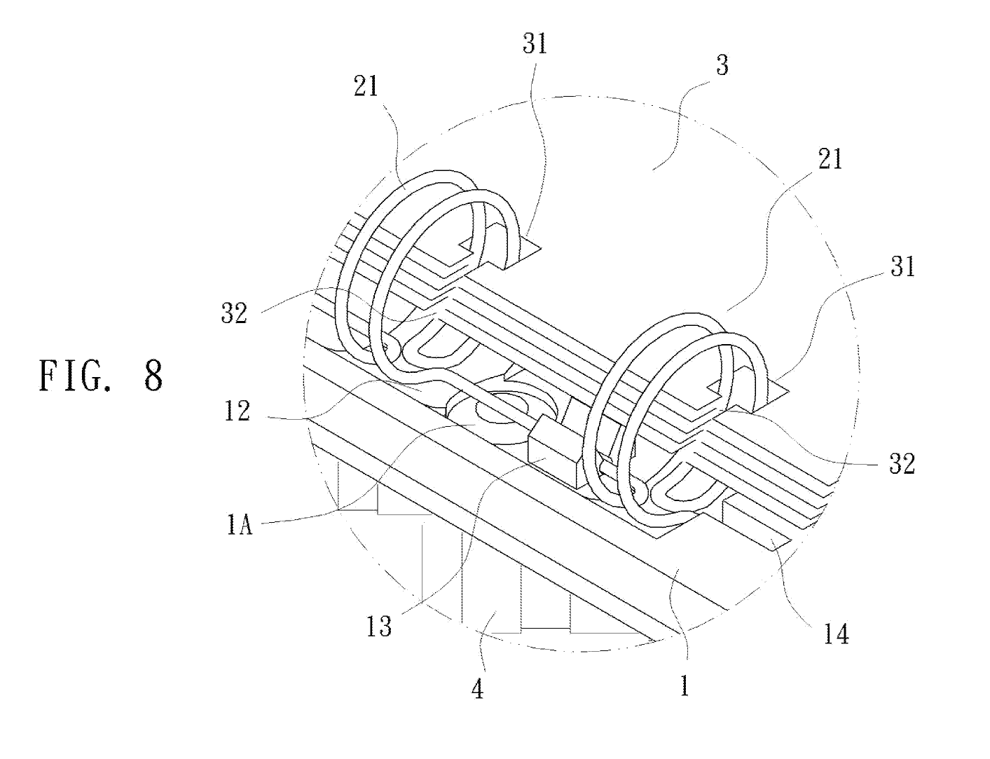

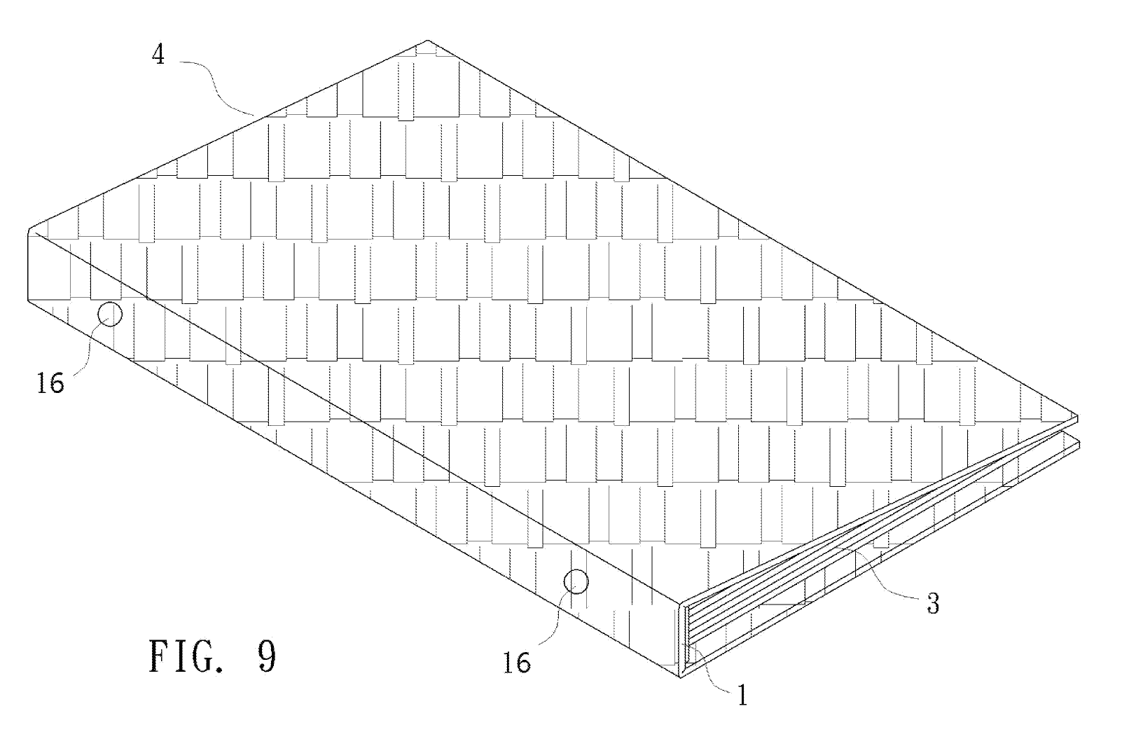

Referring to FIGS. 2 to 9, a loose-leaf binder in accordance with the invention comprises the following components as discussed in detail below.

A cover 4 formed of rigid material has an intermediate portion for dividing the cover 4 into two equal halves which can be open or closed as well known in the art. Two spaced eyelets 41 on provided on the intermediate portion of the cover 4.

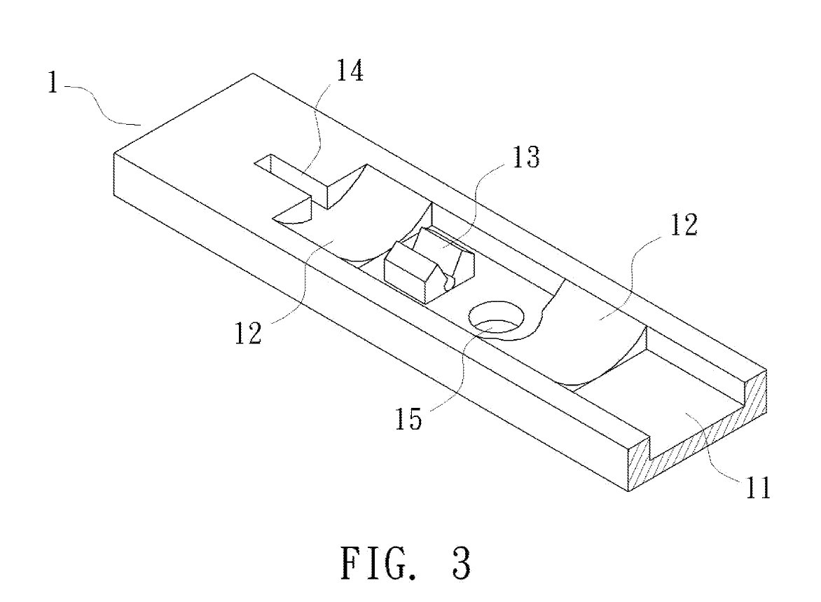

As shown in FIGS. 2 and 3, a sheet retaining mechanism 1 is an elongated member having two rectangular ends. The top surface of the sheet retaining mechanism 1 is concave to form the following components. An elongated, rectangular recess 11 is formed. A slit 14 is provided at either end of the recess 11. A plurality of sections are formed on the recess 11 and each section has an upward concave member 12 on either end, and a fork shaped clamp 13 between both ends. Two holes 15 are provided on the recess 11 in which one hole 15 is through the bottom of the left section and the other hole 15 is through the bottom of the right section. Each hole 15 is disposed between the concave member 12 and the clamp 13. Two fasteners (e.g., rivets) 16 can be driven through the eyelets 41 into the holes 15 to secure the cover 4 to the sheet retaining mechanism 1.

A continuous metal wire 2 is shaped to form a plurality of flexible, spaced C-shaped rings 21 on a portion 23 between both straight ends 22. A plurality of sheets of paper 3 each has a plurality of equally spaced, rectangular holes 31 along the inner lateral edge formed by punching. Each hole 31 has a slit shaped channel 22 having one end extending to the lateral edge.

In a binding operation, a plurality of sheets of paper 3 can be stacked together. Next, a person may enlarge the openings of the C-shaped rings 21 by pivotably pulling upper portions of the rings 21. Next, place the inner lateral sides of the sheets of paper 3 in the openings of the rings 21. Next, align the ends of the rings 21 with the holes 31. Next, press the rings 21 until each ring 21 loops through the hole 31. As a result, the sheets of paper 3 are bound. It is noted that the width of the ring 21 is sufficiently greater than that of the slit 32 and less than that of the hole 31. Hence, the sheets of paper 3 are lockingly bound without worrying being removed unintentionally.

Next, ends 22 of the wire 2 are pressed into the slits 14 to be retained therein with the portion 23 being fastened by the clamps 13. Also, the rings 21 are urged against the concave members 12. This finishes the assembly of the loose leaf binder.

While the invention has been described in terms of preferred embodiments, those skilled in the art will recognize that the invention can be practiced with modifications within the spirit and scope of the appended claims.

What is claimed is:

1. A loose-leaf binder comprising:
a folding cover;
a sheet retaining mechanism secured to a folding portion of the cover and comprising an elongated, rectangular recess, a slit at either end of the recess, a plurality of spaced concave members between both ends, and a plurality of spaced clamps between both ends; and
a continuous wire having two straight ends and comprising a plurality of flexible spaced C-shaped rings connected together, the C-shaped rings being adapted to retain a plurality of sheets of paper,
wherein the ends of the wire are retained in the slits, a portion of the wire between both ends is fastened by the clamps, and the C-shaped rings are urged against the concave members.
